(19) United States
(12) Patent Application Publication
(10) Pub. No.: US 2011/0055507 A1
(43) Pub. Date: Mar. 3, 2011

(54) SYSTEM AND METHOD FOR RESTRICTING THE FUNCTION OF A STORAGE DEVICE BASED ON GEOGRAPHICAL LOCATION

(75) Inventor: Xuefeng Cai, Shenzhen (CN)

(73) Assignee: NETAC TECHNOLOGY CO. LTD., Shenzin (CN)

(21) Appl. No.: 12/832,445

(22) Filed: Jul. 8, 2010

(30) Foreign Application Priority Data
Aug. 31, 2009 (CN) 200910169687.0

(51) Int. Cl. G06F 12/14

(52) U.S. Cl. 711/163; 711/E12.091

(57) ABSTRACT

A storage device capable of restricting its functions based on its geographical location is disclosed. In one embodiment, the storage device comprises a storage module for storing data; a positioning module, the positioning module determines the current location of the storage device; and a control module, the control module determines if the storage device is located within an area for function-restriction; and if so, one or more storage functions of the storage module is restricted; if not, the storage module assumes normal operation.

### FIELD OF INVENTION

This patent application relates to storage devices whose functions can be restricted based on its geographical location and methods for achieving the function-restriction.

### BACKGROUND

The development of the computer industry creates more and more applications of data storage devices. A common storage device usually includes a storage module and a control module. When the storage device is connected to an external device, storage of data in the storage module may be achieved through the control actions of the control module.

In certain circumstances, especially when the data stored in the storage module contains important information or confidential information, it may be desirable to protect the data in the storage device and restrict one of more functions of the storage device, such as read, write or erase functions, according to its specific location (geographic position). However, there is currently no storage device that realizes such a function-restriction feature.

### SUMMARY OF THE INVENTION

In one aspect of the invention, a storage device whose functions can be restricted according to its geographical location is provided. Such a storage device comprises:
a storage module for storing data;
a positioning module, the positioning module determines the current location of the storage device; and
a control module, the control module determines if the storage device is located within an area for function-restriction; and if so, one or more storage functions of the storage device are restricted; if not, the storage module assumes normal operation.

In another aspect of the invention, a method for restricting the functions of a storage device based on the device's geographical location is provided. Such a method comprises the steps of:
determining if there exist one or more pre-defined geographical areas for function-restriction;
if there exist one or more pre-defined geographical areas for function-restriction, then determining the current geographical position of the storage device;
   determining if the storage device's current geographical location is within a pre-defined geographical area, and
   restricting one or more data storage functions of the storage device, if the storage device's current geographical location is within a pre-defined geographical area, or
   allowing the data storage device to assume normal operation, if the storage device's current geographical location is not within any pre-defined geographical area.

Therefore, the storage device and method provided by this invention can restrict the functions of a storage device based on the device's geographic location, and thus enhance the security of data stored in the storage device.

### BRIEF DESCRIPTION OF THE DRAWINGS

FIG. 1 demonstrates a storage device whose functions can be restricted based on its geographical location according to one embodiment of the invention;

FIG. 2 demonstrates a storage device whose functions can be restricted based on its geographical location according to another embodiment of the invention;

FIG. 3 demonstrates a method for restricting the functions of a storage device based on its geographical location according to yet another embodiment of the invention;

FIG. 4 demonstrates a method for restricting the functions of a storage device based on its geographical location according to yet another embodiment of the invention.

### DETAILED DESCRIPTION OF PREFERRED EMBODIMENTS

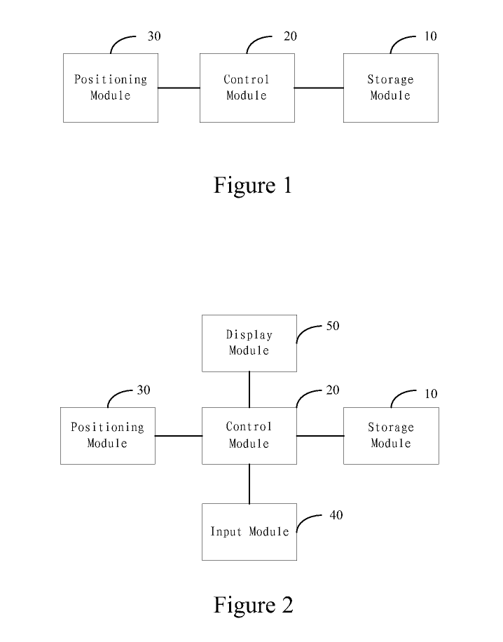

FIG. 1 demonstrates a storage device whose functions can be restricted based on its geographical location according to one embodiment of the invention. According to FIG. 1, the storage device comprises a storage module 10, a control module 20 and a positioning module 30. The storage module 10 is used to store data, such as financial data, management data, information data, or military data, etc. The positioning module 30 determines the location of the storage device. The control module 20 determines if the storage device is located within an area for function-restriction. If the storage device is located in an area for function-restriction, then one or more functions of the storage device will be restricted according to pre-defined function-restricting patterns. Such function-restricting patterns may include prohibiting the read, write or erase operations on data stored in the storage device. Such a restriction of functions may be achieved by controlling the storage device to prohibit the execution of certain specific operations on the data it stores. For example, the control module 20 may instruct the storage device not to accept any operational command, thereby prohibiting any operation on the stored data. Of course, what is described here is only one example of achieving the function-restriction feature. Other means may be used to achieve the restriction of storage functions on the stored data.

In one embodiment, the control module 20 includes a RAM memory module. Programs used by the control module 20 to achieve its functions may be stored in the RAM memory module.

In another embodiment, the above-mentioned geographical areas for function-restriction may be a set of pre-defined locations for the storage module. The set of pre-defined locations may be stored in the storage module 10.

In yet another embodiment, according to FIG. 2, the storage device may also include an input module 40. The input module 40 allows an authorized user to enter self-defined parameters that specify the geographical locations for function-restriction. The input module 40 may be a well-know input device in the field, such as a key board. An authorized user is a user who is given the permission to enter geographical parameters for function-restriction. The purpose of assigning authorized users is to prevent the random entry of geographical parameters by any user. The granting of access to an authorized user may be achieved, for example, by providing a login ID and password to the authorized user.

Moreover, according to FIG. 2, the storage device may also include a display module 50. When an authorized user is entering geographical parameters, the control module 20 may provide prompts to the user through the display module 50, and guide the user to enter the correct parameters. The display module 50 may be a well-known display device, such as a LCD display.

According to one embodiment of the invention, the positioning module 30 may be any device that can obtain information of geographical position, such as a GPS device, a satellite navigation and positioning system or a rangefinder, etc.

In one embodiment, the control module 20 communicates with and controls the operations of the storage module 10, the positioning module 30, the input module 40 and the display module 50 via data packages that contain certain control command packages. The control command packages contained in the data packages may include: set geographical locations command package; display information command package; result inquiry command package; as well as return result command package.

Among the command packages, the set geographical locations command package may further include other command package according to the specific parameters required. For example, if the geographical location is a circle defined by a center point and a radius r, wherein the center point is defined by its latitude x and longitude y; then the set geographical locations command package may further include: a set latitude command package, a set longitude command package and a set radius command package.

When an authorized user is entering the parameters, the control module 20 sends the set latitude, set longitude and set radius command packages to the input module 40, and sends the display information command package to the display module 50 to display prompts on the display module 50. The prompts help the authorized user to enter the corresponding parameters (i.e. latitude x, longitude y and radius r) to define the geographical location for function-restriction. The control module 20 then sends the result inquiry command package to the positioning module 30 to learn the current location of the storage device determined by the positioning module 30. The control module 20 then compares the current location and the function-restriction locations entered by the authorized user and determines if the current location is within a function-restriction location. If so, then the control module 20 exercises restrictions on one or more functions of the storage device. The control module 20 may also use the return result command package to inform the authorized user through the display module 50 that “function of the storage device is restricted because the device is within a geographical location for function-restriction”. If the current location is not within a function-restriction location, then the control module 20 allows the storage device to assume normal operation. The control module 20 may also use the return result command package to inform the authorized user through the display module 50 that “the storage device is operating normally because the device is not within a geographical location for function-restriction”.

In another embodiment, a data package may include three parts. The first part (for example, the first byte) contains the type of command. The second part (for example, the second byte) contains the size of the data package. The third part (its length is determined by the size shown in the second part) contains the content of the data package. For example, the third part of the set geographical location command package may include 4 bytes, the first two bytes contain the integer portions of the parameters such as latitude, longitude and radius and the last two bytes contain the decimal portions of these parameters.

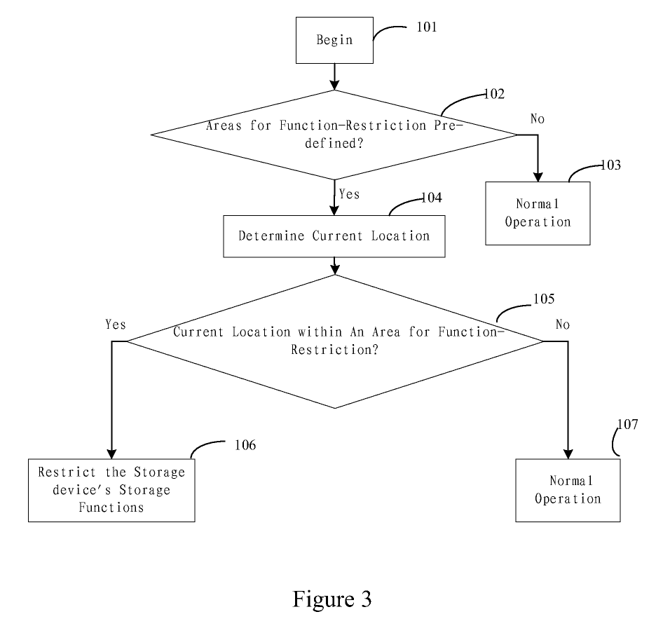

FIG. 3 shows one embodiment of the method for achieving function-restriction based on a storage device's geographical location.

According to FIG. 3, when the storage device starts operating (step 101), it first in step 102 determines if a geographical location for function-restriction has been pre-defined. If not, the storage device enters step 103 to allow the storage module to assume normal data storage operation; if yes, the storage device enters step 104 to determine its current location. Then, in step 105, the storage device determines if its current location is within a pre-defined geographical location for function-restriction. If yes, it restricts one or more of its storage functions in step 106. If not, it allows the storage module to assume normal operation in step 107. Possible function-restrictions may include prohibiting the read, write or erase operations on the data stored in the storage device. As an exemplary embodiment of function-restriction, when the control module determines that the storage device is within a function-restriction location, it will instruct the storage device not to accept any operational command, thereby prohibiting any operation on the stored data.

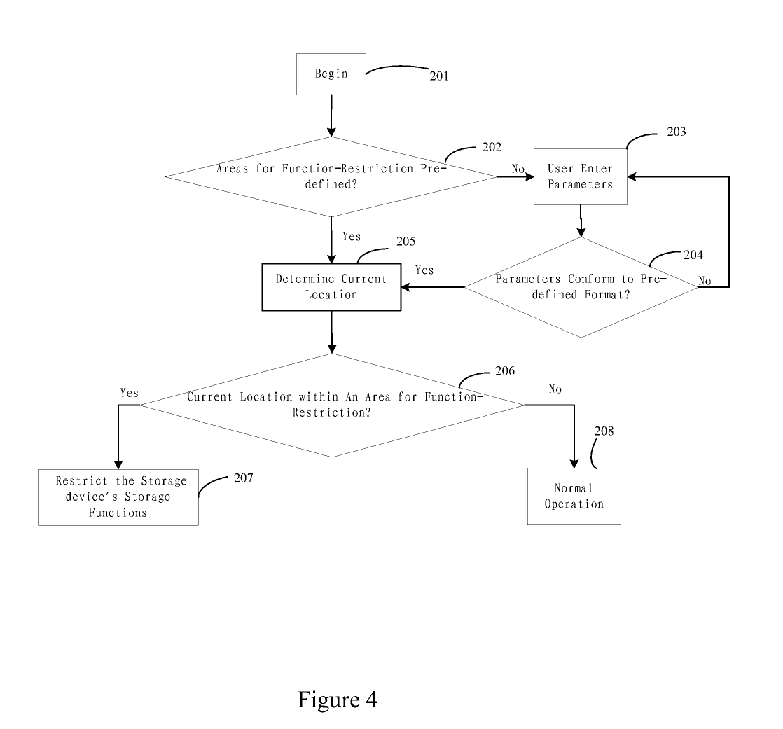

FIG. 4 shows another embodiment of the method for achieving function-restriction based on a storage device's geographical location. In this embodiment, an authorized user can define the geographical areas for function-restriction.

According to FIG. 4, when the storage device starts operating (step 201), it first in step 202 determines if a geographical location for function-restriction has been pre-defined. If yes, it enters 205; if not, it enters step 203 to allow an authorized user to enter geographical parameters to define the function-restriction areas. After the authorized user enters the parameters, the storage device in step 204 checks if the parameters are entered in conformity with a pre-defined format, i.e. if the parameters can be used to determine valid geographical areas for function-restriction. For example, the storage device can check if the parameters entered include latitude and longitude, or if the number of bytes entered matches the number of bytes that is pre-defined for latitude and longitudes , or if the parameters are entered according to a pre-defined format, etc. If the parameters entered by the authorized user do not conform to the pre-defined format, then the process returns to step 203, meaning the authorized user is asked to re-enter the parameters. If valid geographical areas for function-restriction can be determined based on the parameters entered, then the process enters step 205 to determine the current geographical position of the storage device. Then, step 206 determines if the current geographical location of the storage device is within a pre-defined or user-entered area for function-restriction. If yes, then one or more storage functions of the storage device are restricted in step 207; if not, then the storage device assumes normal operation in step 208.

In one embodiment of the invention, information exchange is achieved via data packages. For example, in step 203 above, a “set geographical location” command package may be used to prompt the authorized user to enter parameters to define the geographic areas for function-restriction. A “display information” command package may be used to display information that prompts the authorized user to enter the corresponding parameters. In step 206 above, a “result inquiry” command package may be used to check the current geographical location of the storage device, and determine if the location is within a pre-defined or user-entered geographical area for function-restriction. In steps 207 and 208, a “return result” command package may be used to show the status of function-restriction of the storage device.

In another embodiment of the invention, one or more geographical areas for function-restriction may be pre-defined or set up by authorized users. When entering the parameters, the first parameter entered may be the number of geographical areas for function-restriction, so that the storage device could allocate appropriate memory for storing the number of geographical areas. Next, parameters specifying the types of function-restriction may be entered and parameters describing the geographical areas for each type of function-restriction may be specified. For example, the parameters may specify that in area one (such as the control center of a R&D base), normal data read/write operations by storage devices (such as mobile hard disks) can be performed; while in area two (such as areas within the R&D base other than the control center), normal data read operation is allowed, but any data write operation is prohibited; while in any other area, any data read or write operation is prohibited.

When determining if parameters entered by an authorized user are valid, the measurement error of the positioning module may be taken into consideration. For example, if a GPS positioning module with a positioning error of about 1 meter is used, then in order to improve the accuracy for controlling the storage device, it may be required that the radius parameter entered be larger than 1 meter.

The embodiments described above are just examples of implementing the invention and they shall not be used to limit the scope of the invention. Any revision or replacement within the spirit and principle of the invention shall be included in the scope of protection of this application.

What is claimed is:

1. A storage device capable of restricting its functions based on its geographical location, comprising:
a storage module for storing data;
a positioning module, the positioning module determines the current location of the storage device; and
a control module, the control module determines if the storage device is located within an area for function-restriction; and if so, one or more storage functions of the storage device are restricted; if not, the storage module assumes normal operation.

2. The storage device of claim 1, further comprising an input module, wherein authorized users of the storage device enter parameters defining the geographical locations for function-restriction through the input module.

3. The storage device of claim 2, further comprising a display module, the display module displays information to a user.

4. The storage module of claim 3, wherein the control module checks if the parameters entered by an authorized user specify a valid area for function-restriction, and if not, the control module, through the display module, prompts the authorized user to re-enter the parameters.

5. The storage device of claim 3, wherein the control module communicates with and controls the storage module, the positioning module, the input module and the display module via data packages.

6. The storage device of claim 5, wherein the data packages comprise a set geographical locations command package, a display information command package, a result inquiry command package, as well as a return result command package; and wherein
the control module uses the set geographical locations command package to communicate with the input module to allow the authorized user to enter parameters;
the control module uses the display information command package to communicate with the display module to display information that help the authorized user to enter parameters;
the control module uses the result inquiry command package to communicate with the positioning module to determine the storage device's current location; and
the control module uses the return result command package to communicate with the display module to display the status of function-restriction of the storage device on the display module.

7. The storage device of claim 6, wherein the set geographical locations command package comprises a set latitude command package, a set longitude command package and a set radius command package.

8. The storage device of claim 5, wherein the data packages comprise three parts; the first part containing the types of command residing in the data package, the second part containing the size of the data package, and the third part containing the content of the data package.

9. A method for restricting the functions of a storage device based on the storage device's geographical location, comprising the steps of:
determining if there exist one or more pre-defined geographical areas for function-restriction;
if there exist one or more pre-defined geographical areas for function-restriction, then determining the current geographical position of the storage device;
determining if the storage device's current geographical location is within a pre-defined geographical area; and
restricting one or more data storage functions of the storage device, if the storage device's current geographical location is within a pre-defined geographical area, or
allowing the data storage device to assume normal operation, if the storage device's current geographical location is not within any pre-defined geographical area.

10. The method of claim 9, further comprising the steps of:
prompting an authorized user to enter parameters defining one or more geographical areas for one or more forms of function-restriction;
determining if the parameters entered specify one or more valid geographical areas for function-restriction; and
prompting the authorized user to re-enter the parameters, if the parameters entered do not specify any valid geographical area for function-restriction.
